(19) United States
(12) Patent Application Publication
(10) Pub. No.: US 2006/0180067 A1
(43) Pub. Date: Aug. 17, 2006

(54) Sewing thread and sewn fabric product

(76) Inventors: Hiroshi Yamazaki, Osaka (JP); Yasunori Yuuki, Hyogo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/541,397

(22) PCT Filed: Jan. 8, 2004
(86) PCT No.: PCT/JP04/00065

§ 371 Date: Jul. 1, 2005

(30) Foreign Application Priority Data
Jan. 8, 2003 (JP) 2003-002430

(51) Int. Cl. B32B 7/08

(52) U.S. Cl. 112/413

(57) ABSTRACT

A sewing thread containing 30% by weight or more of a poly(trimethylene terephthalate)-based staple fiber, and showing a breaking elongation of 30 to 100% and an instantaneous elastic recovery at a 5% elongation of 30 to 75%. This improved sewing thread has excellent suitability for sewing. With this sewing thread, sewn clothes which give no tight feeling and are highly comfortable to wear can be made.

### TECHNICAL FIELD

The present invention relates to a sewing thread formed out of a poly(trimethylene terephthalate)-based staple fiber, having stretchability and being excellent in lock stitch sewing performance, and to sewn fabric articles prepared using the sewing thread.

### BACKGROUND ART

When a fabric having stretchability is sewn with a general-purpose sewing thread having no stretchability, it has heretofore been natural that the stretchability of the fabric in the seamed portions is lowered, and the advantage of the stretchable fabric has not been utilized. Moreover, when an excessive elongating force is applied to the seams of a sewn stretchable fabric, the sewn fabric has the disadvantage that the sewing thread having no stretchability is easily broken.

Accordingly, when stretchability must be given to the seams, the following has been practiced: the stretchability of the seams is manifested by forming seams having a structure of a double-thread chain stitch, an overlock stitch or a zigzag stitch. However, these seams have the following drawbacks: a special sewing machine is required in order to form the structures; formation of the seams requires much time; a large amount of a sewing thread is used; and the seams have a poor appearance. Moreover, the stretchability of the fabric in the seamed portions of the fabric is not necessarily satisfactory.

A yarn obtained by combining an elastic fiber such as a polyurethane-based fiber and a soluble yarn has been known as a known machine sewing thread used for sewing a stretchable fabric. However, the sewing thread has drawbacks in that it shows a poor sewing performance and that its production requires a step of removing the soluble yarn to raise the sewing cost.

The pamphlet of International Patent Publication WO00/73553 discloses a machine sewing thread suitable for sewing a stretchable fabric. The pamphlet discloses as follows: the disclosed machine sewing thread is formed out of a poly(trimethylene terephthalate) multifilament yarn; the sewing thread shows a specific elongation curve; the sewing thread can be used for lock stitch sewing, and the seam stretchability is excellent; and the sewn articles thus obtained do not constrain the wearers and give them a comfortable feel. The disclosed invention has made the following conclusions: the sewing thread makes use of the properties of a poly(trimethylene terephthalate) fiber of both a high breaking elongation and an excellent elastic recovery; the sewing thread is excellent in seam stretchability, and is very excellent as one for sewing a fabric having particularly high stretchability.

However, it has been found that although the sewing thread maintains a sufficient sewing performance level during sewing with a machine at a speed of rotation of about 1,000 rpm, the sewing performance level is not always satisfactory during sewing articles on a commercial basis, namely, at a speed of rotation of about 4,000 rpm. Moreover, in order to improve the sewing performance, silicone, or the like, is commonly applied to the fiber. The resultant sewing thread tends to show a slight improvement of a sewing performance. However, the degree of improvement has not been satisfactory.

### DISCLOSURE OF THE INVENTION

An object of the present invention is to provide a stretchable machine sewing thread having a high stretchability, and showing an excellent lock stitch sewing performance for a fabric, and a sewn article prepared from a stretchable fabric and having seams that have an excellent appearance and stretchability.

In order to solve the above problems, the present inventors have first investigated the relationship between a seam formation mechanism and the elongation properties of a sewing thread.

The seam during lock stitching is formed in the following manner: when a needle passes a bottom dead point and slightly moves upward, a loop of a needle thread is formed near the hole of the needle, and a needle tip scoops the loop. Accordingly, it becomes very important to form a large loop as stably as possible for the purpose of improving the sewing performance.

For a general-purpose nonstretchable sewing thread, when the needle thread (sewing thread) passes a fabric together with a needle, the elongation of the machine sewing thread is suppressed by frictional resistance, etc. As a result, a large loop is stably formed, and the sewing performance is not hindered. However, for such a machine sewing thread having stretchability as disclosed in the pamphlet of International Patent Publication WO00/73553, the machine sewing thread is elongated when the needle thread passes a fabric during sewing, and the needle thread is shrunk in the loop formation stage due to a very high elastic recovery, resulting in forming only a small loop. That is, it has been found that there is no obstacle at a speed of rotation of about 1,000 rpm, and that the sewing performance is worsened due to the formation of a small loop in sewing articles on a commercial basis, namely, at a speed of rotation as high as about 4,000 rpm. As explained above, when a machine sewing thread showing a high breaking elongation and a high elastic recovery is used in order to impart stretchability to seams, the sewing performance is worsened inversely proportional to the physical values due to the above seam formation mechanism. Imparting stretchability to the seams is incompatible with the sewing performance.

Based on such knowledge, the present inventors have investigated in detail the relationship between a seam formation mechanism and various elongation properties of a machine sewing thread concerning the factors affecting the relationship. As a result, they first elucidated that the elastic recovery contributes more to the sewing performance than the breaking elongation. They have then thoroughly investigated the relationship between an elastic recovery and a sewing performance at various degrees of elongations. They have consequently found that an instantaneous elastic recovery in a low elongation region greatly contributes to the sewing performance, and that the breaking elongation greatly contributes to imparting stretchability to the seams.

That is, as to the sewing performance, the present inventors have made the following discoveries. When the instantaneous elastic recovery is high in a low elongation region, a large loop is hardly formed. Suppression of an instantaneous elastic recovery stabilizes the loop formation, and the action and effect are fully displayed even at a high speed of rotation. The breaking elongation contributes more to imparting stretchability to the seams than the instantaneous elastic recovery in a low elongation region.

Based on the above knowledge, the present inventors investigated in more detail. As a result, they have elucidated that there is a significant relationship between a sewing performance and an instantaneous elastic recovery at a 5% elongation, and that there is also a significant relationship between imparting stretchability to the seam and a breaking elongation. Based on the above knowledge, they have investigated the relationship between various factors constituting the sewing thread, namely, a combination of a fiber type, a fiber length, a size, a number of twists, and the like, and elongation properties, by repeating detailed and thorough trial preparations and experiments. Astonishingly, they have thus discovered that the problems of the invention can be solved by using a yarn of a poly(trimethylene terephthalate)-based staple fiber, and they have achieved the present invention.

That is, the present inventors have started from elucidation of the problem that the conventional technological idea cannot make the stretchability of seams compatible with the sewing performance. They have then found new characteristic values directly connecting the sewing performance. They have further repeated detailed and thorough trial preparations of various sewing threads satisfying the characteristic values, and experiments, and they have achieved the present invention.

The present invention is as explained below.

1. A sewing thread containing 30% by weight or more of a poly(trimethylene terephthalate)-based staple fiber, and showing a breaking elongation of 30 to 100% and an instantaneous elastic recovery at a 5% elongation of 30 to 75%.

2. The sewing thread according to 1., wherein the elastic recovery at a 20% elongation is 60% or more.

3. A sewing thread according to 1., wherein the elastic recovery at a 30% elongation is 60% or more.

4. Sewn fabric articles wherein the seams of the sewn fabric articles are formed with the sewing thread according to any one of 1. to 3.

5. The sewn fabric articles according to 4., wherein the sewn fabric articles are stretchable ones.

The present invention is explained below in detail.

The poly(trimethylene terephthalate)-based staple fiber in the present invention is a staple fiber formed out of 100% of a poly(trimethylene terephthalate) and/or a conjugate filament at least one component of which is formed out of a poly(trimethylene terephthalate).

In the present invention, a poly(trimethylene terephthalate) designates a polyester that has trimethylene terephthalate repeating units as principal repeating ones, and that contains the trimethylene terephthalate units in an amount of preferably about 50% by mol or more, more preferably 70% by mol or more, still more preferably 80% by mol or more, and most preferably 90% by mol or more. The poly(trimethylene terephthalate) according to the present invention therefore includes a poly(trimethylene terephthalate) that contains as a third component other acid components and/or glycol components in a total amount of preferably about 50% by mol or less, more preferably 30% by mol or less, still more preferably 20% by mol or less, and most preferably 10% by mol or less.

Poly(trimethylene terephthalate) is produced by condensation polymerizing terephthalic acid or its functional derivative such as dimethyl terephthalate and trimethylene glycol or its functional derivative in the presence of a catalyst under suitable reaction conditions. In the course of the production, one or two or more of the suitable third components may also be added to be copolymerized. Alternatively, a polyester other than a poly(trimethylene terephthalate) such as a poly(ethylene terephthalate) and a nylon, etc. may be blended with a poly(trimethylene terephthalate).

Examples of the third components to be added include aliphatic dicarboxylic acids such as oxalic acid and adipic acid, alicyclic dicarboxylic acids such as cyclohexanedicarboxylic acid, aromatic dicarboxylic acids such as isophthalic acid and sodium sulfoisophthalate, aliphatic glycols such as ethylene glycol, 1,2-propylene glycol and tetramethylene glycol, alicyclic glycols such as cyclohexanedimethanol, aliphatic glycols each having an aromatic group such as 1,4-bis(β-hydroxyethoxy)benzene, polyether glycols such as polyethylene glycol and polypropylene glycol, aliphatic oxycarboxylic acids such as ω-oxycaproic acid and aromatic oxycarboxylic acids such as p-oxybenzoic acid. Moreover, a compound having one or three or more ester-forming functional groups such as benzoic acid or glycerin may also be employed as long as the resultant polymers are substantially linear.

The poly(trimethylene terephthalate)-based staple fiber may also be allowed to contain delustering agents such as titanium dioxide, stabilizing agents such as phosphoric acid, ultraviolet-ray absorbers such as a hydroxybenzophenone derivative, nucleating agents such as talc, lubricants such as Aerosil, antioxidants such as a hindered phenol derivative, flame retardants, electrostatic eliminating additives, antistatic agents, delustering agents, pigments, fluorescent brighteners, infrared-ray absorbers, defoaming agents, and the like.

In the present invention, the poly(trimethylene terephthalate)-based staple fiber is not restricted to a staple fiber formed out of one type of poly(trimethylene terephthalate), but it may also be a staple fiber containing at least two types of poly(trimethylene terephthalate) different from each other in polymerization degree or copolymerization composition, or a staple fiber in which at least one component is poly(trimethylene terephthalate) and which further contains other components. For example, a latent crimp polyester staple fiber is a preferred example of the staple fiber.

The latent crimp polyester staple fiber is formed out of at least two types of polyester components (specifically, bonded in a side by side manner or in an eccentric sheath-core manner mostly), and crimp is manifested by heat treatment. There is no specific limitation on the mixing ratio of two types of polyester components (generally, most of the ratios being from 70/30 to 30/70 (weight ratio)), the bonded cross-sectional shape (some of the shapes being linear or curved), and the like. Moreover, a preferred single filament size is from 0.5 to 10 dtex. However, the size is not restricted to the above value.

The latent crimp polyester staple fiber is satisfactory as long as at least one component thereof is a poly(trimethylene terephthalate). Specifically, the staple fiber contains poly(trimethylene terephthalate), as disclosed in Japanese Unexamined Patent Publication (Kokai) No. 2001-40537, as at least one component. That is, the staple fiber is a conjugate fiber in which two types of polyester polymers are bonded in a side-by-side manner or an eccentric sheath-core manner. For a conjugate fiber in which two types of polyester polymers are bonded in a side-by-side manner, the melt viscosity ratio between the two types of polyester polymers is preferably from 1.00 to 2.00. For a conjugate fiber in which two types of polyester polymers are bonded in an eccentric sheath-core manner, the ratio of an alkali reduction rate of a sheath polymer to an alkali reduction rate of a core polymer is preferably 3 or more.

For the latent crimp polyester staple fiber in the present invention, at least one of the polyester components forming the staple fiber is poly(trimethylene terephthalate). For example, a first component is a poly(trimethylene terephthalate), and a second component is a polymer selected from polyesters such as a poly(trimethylene terephthalate), a poly(ethylene terephthalate) and a poly(butylene terephthalate). The staple fiber is obtained by conjugate spinning in a side-by-side manner (two components being arranged in parallel) or in an eccentric sheath-core manner (two components being arranged eccentrically). In particular, a combination of a poly(trimethylene terephthalate) and a copolymerized poly(trimethylene terephthalate) and a combination of two types of poly(trimethylene terephthalate) differing from each other in intrinsic viscosity are preferred.

Specific examples of such latent crimp polyester staple fibers are disclosed in, in addition to Japanese Unexamined Patent Publication (Kokai) No. 2001-40537 described above, Japanese Examined Patent Publication (Kokoku) No. 43-19108, Japanese Unexamined Patent Publication (Kokai) No. 11-189923, Japanese Unexamined Patent Publication (Kokai) No. 2000-239927, Japanese Unexamined Patent Publication (Kokai) No. 2000-256918, Japanese Unexamined Patent Publication (Kokai) No. 2000-328382, Japanese Unexamined Patent Publication (Kokai) No. 2001-81640, and the like

The intrinsic viscosity difference between two types of poly(trimethylene terephthalate) is preferably from 0.05 to 0.4 (dl/g), more preferably from 0.1 to 0.35 (dl/g) and still more preferably from 0.15 to 0.35 (dl/g). For example, when the intrinsic viscosity on the high viscosity side is selected from a range of 0.7 to 1.3 (dl/g), the intrinsic viscosity on the low viscosity side is preferably selected from a range of 0.5 to 1.1 (dl/g). In addition, the intrinsic viscosity on the low viscosity side is preferably 0.8 (dl/g) or more, more preferably from 0.85 to 1.0 (dl/g) and still more preferably from 0.9 to 1.0 (dl/g).

Furthermore, the average intrinsic viscosity of such a conjugate fiber is preferably from 0.7 to 1.2 (dl/g), more preferably from 0.8 to 1.2 (dl/g), still more preferably from 0.85 to 1.15 (dl/g) and most preferably from 0.9 to 1.1 (dl/g).

In addition, the intrinsic viscosity value in the present invention does not designate the viscosity of the polymer used, but it designates the viscosity of the spun yarn for the following reasons. A poly(trimethylene terephthalate) is likely to be thermally decomposed in comparison with a poly(ethylene terephthalate), or the like. As a result, even when a polymer having a high intrinsic viscosity is used, the intrinsic viscosity is lowered by thermal decomposition during a spinning process. The resultant conjugate fiber thus obtained therefore hardly maintains the intrinsic viscosity difference of the raw material polymers.

The poly(trimethylene terephthalate)-based staple fiber used in the present invention is obtained by, for example, the following methods.

There is a method comprising melt spinning a poly(trimethylene terephthalate) having an intrinsic viscosity of 0.4 to 1.9, preferably 0.7 to 1.2, winding the resultant yarn at a rate of about 1,500 m/min to give an undrawn yarn, and drawing the undrawn yarn by a draw ratio of about 2 to 3.5. There is a direct drawing method (spin-draw method) in which a spinning process and a drawing process are directly connected. There is also a high speed spinning method (spin-take up method) in which a spun yarn is wound at a rate of 5,000 m/min or more to give a filament yarn.

The filament yarn thus obtained is continuously bundled to form a tow. Alternatively, the filament yarn once wound in a package is unwound, and bundled to form a tow to which a finish oil for spinning is applied. The tow is optionally heat treated, crimped to have crimps, and cut at a predetermined length to give a staple fiber. When the filament yarn is once wound in a package and unwound and bundled, a finish oil for filament yarn is applied. Accordingly, a finish oil for spinning is preferably applied to the tow after removing the finish oil for filament yarn. In addition, a melt spun undrawn yarn may also be bundled to form a tow, and drawn. However, in order to obtain a uniform staple fiber, a tow is preferably formed after drawing.

In melt spinning, a partially oriented undrawn yarn obtained by taking up a spun yarn at a winding rate of preferably 2,000 m/min or more, more preferably 2,500 to 4,000 m/min or more can also be used. The undrawn yarn is then drawn by a natural draw ratio or less, and preferably crimped. Moreover, the crimped yarn in a tow state may also be subjected to a spinning process without cutting into a staple fiber in advance; the resultant yarn is then cut by a tow draft-cutting machine to form a staple fiber, and a spun yarn is obtained therefrom.

A poly(trimethylene terephthalate)-based fiber has the specific problem that the fiber-to-fiber frictional force compared with that of a poly(ethylene terephthalate) fiber, or the like is high. However, application of a proper finish oil for spinning in a proper amount gives a spun yarn having excellent spinnability and high uniformity. Principal objects of applying a finish oil to a poly(trimethylene terephthalate)-based staple fiber is to give electrostatic eliminating properties, lower a fiber-to-fiber frictional force so that the openability of the fiber is improved, impart proper cohesiveness on the other hand, and decrease a fiber-to-metal frictional force so that the fiber in the opening process is prevented from being damaged. An anionic surfactant often used as an antistatic agent is preferred as the finish oil. For example, the finish oil is preferably one containing as its major component an alkyl phosphate salt with an alkyl group having average carbon atoms of 8 to 18. The finish oil is more preferably one containing as its major component a potassium alkyl phosphate with an alkyl group having average carbon atoms of 8 to 18. The finish oil is most preferably one containing, as a major component, a potassium alkyl phosphate with an alkyl group having average carbon atoms of 10 to 15.

Specific examples of the alkyl phosphate salt include potassium lauryl phosphate (average carbon atoms of 12), potassium cetyl phosphate (average carbon atoms of 16) and potassium stearyl phosphate (average carbon atoms of 18). However, the finish oil is not restricted to such substances. The content of an alkyl phosphate salt in the finish oil component is preferably from 50 to 100% by weight and more preferably from 70 to 90% by weight.

In order to improve the smoothness and prevent damage to a fiber, the finish oil may further be allowed to contain as other finish oil components an animal or vegetable oil, a mineral oil, an aliphatic acid ester-based compound or an aliphatic higher alcohol, or a nonionic surfactant composed of a substance such as an oxyethylene compound, an oxypropylene compound, or the like compound of an aliphatic acid ester of a polyhydric alcohol, in an amount of 50% by weight or less, preferably 10 to 30% by weight.

An adhesion amount of a finish oil for spinning is preferably from 0.05 to 0.5% o.m.f., more preferably from 0.1 to 0.35% o.m.f. and still more preferably from 0.1 to 0.2% o.m.f. When selection of a finish oil is appropriate and an adhesion amount is in the above range, a spun yarn excellent in spinnability and having high uniformity is obtained. However, when an adhesion amount of a finish oil is excessive, a yarn in a carding process is likely to be wound around a cylinder, or a yarn is likely to be wound around a top roller (rubber roller) in the roller draft step of drawing, roving, spinning, or the like process. Conversely, when an adhesion amount of a finish oil is too small, a staple fiber in the opening process is likely to be damaged; or static electricity is excessively generated in the above roller draft step, and the yarn is likely to be wound around a bottom roller (metal roller). The influence of a finish oil is particularly significant in a spinning process. When a staple fiber is wound around a top roller or a bottom roller as explained above, yarn breakage increases, and the uniformity of the yarn is lowered.

Furthermore, when a poly(trimethylene terephthalate)-staple fiber is to be crimped, there is no specific limitation on the method of crimping. In view of the excellent productivity and crimp shape, crimping with a stuffer box is preferred. In order to make the openability and processability in the spinning process excellent, the number of crimps (according to the test method of number of crimps by JIS L 1015) is preferably from 3 to 30/25 mm, and more preferably from 5 to 20/25 mm. Moreover, the degree of crimp (according to the test method of degree of crimp by JIS L 1015) is preferably from 2 to 30%, and more preferably from 4 to 25%.

Furthermore, when the fiber length is shorter, the number of crimps becomes larger in the above ranges, and it is preferred that the number of crimps and the degree of crimp be increased within the above ranges. More specifically, when the fiber length is 38 mm (cotton spinning process), it is preferred that the number of crimps and the degree of crimp be 16± 2/25 mm and 18±3%, respectively. When the fiber length is 51 mm (synthetic fiber spinning process), it is preferred that the number of crimps and the degree of crimp be 12± 2/25 mm and 15±3%, respectively. With respect to bias cut fibers having a fiber length of 64 mm or more (worsted spinning process), it is preferred that the number of crimps and the degree of crimp be 8± 2/25 mm and 12±3%, respectively. In the woolen process (uniform fiber length of 51 mm), it is preferred that the number of crimps and the degree of crimp be 18± 2/25 mm and 20±3%, respectively. Moreover, when the fiber is processed through a carding machine of a high-speed type, the crimp tends to be elongated. It is therefore preferred that the degree of crimp be increased by 2 to 5% in comparison with the above ranges.

When the number of crimps and the degree of crimp fall within the above ranges, at the carding process, the occurrence of web dangling from a web collecting calender roller or sliver breakage at a coiler calender roller can be avoided, and the carding processability becomes excellent. Further, the openability becomes excellent, and the occurrence of a nep or a slub becomes rare. Still further, excellent spinnability can be attained, and as a result a spun yarn of high uniformity can be obtained. The cross section of a single filament of the poly(trimethylene terephthalate)-based staple fiber used in the present invention may be uniform, or thick and thin in the longitudinal direction. The cross section is round-shaped, triangle-shaped, L-shaped, T-shaped, Y-shaped, W-shaped, eight leaf-shaped, flat (flatness of about 1.3 to 4, the cross section being W-shaped, I-shaped, boomerang-shaped, wave-shaped, dumplings on a spit-shaped, cocoon-shaped, rectangular parallelepiped-or the like shaped), polygon-shaped (e.g., dog bone-shaped), multi-leaf-shaped, hollow or indefinitely shaped. Of these cross sections, a round-shaped cross section is particularly preferred.

Furthermore, the single filament size is preferably from 0.1 or more to 10.0 dtex or less. When the yarn is used as a sewing thread, the single filament size is preferably from 1.0 or more to 6.0 dtex or less. The fiber length of the staple fiber may be selected in the range of about 30 to about 160 mm in accordance with the application, spinning system, fiber length of the counterpart material of conjugation, or the like. For a sewing thread, the fiber length is from 30 to about 120 mm, preferably from 30 to 50 mm. In order to obtain a spun yarn showing good spinnability and having good quality, the proportion of ultralong fiber (content of a single fiber having a fiber length larger than a given fiber length) is preferably 0.5% or less.

There is no specific restriction on the method of producing a spun yarn from a poly(trimethylene terephthalate)-based staple fiber used in the present invention. A spinning method such as a conventional cotton spinning system (fiber length of 32 mm, 38 mm, 44 mm), a synthetic fiber spinning system (fiber length of 51 mm, 64 mm, 76 mm), a worsted spinning system (fiber length of 64 mm or more (bias cut)) and a tow spinning method (tow being used) may be applied according to the fiber length of the staple fiber. However, for a sewing thread, the cotton spinning system is preferred. Moreover, there is no specific restriction on a spinning method. A ring spinning method, a rotor type open end spinning method, a friction type open end spinning method, an air-jet spinning method, a hollow spindle spinning method (wrapping spinning method), a self-twist spinning method, and the like spinning method may be applied. However, in order to obtain a sewing thread that makes use of the softness of a poly(trimethylene terephthalate)-based fiber, the ring spinning method is preferred.

The number of twists of a spun yarn should be suitably determined according to the fiber length so that the twist factor falls in the following ranges: a twist factor K in terms of cotton count (K=number of twist (T/2.54 cm)/(cotton count)^{0.5}) of from 1.98 to 4.63; a twist factor α in terms of meter count (α=number of twist (T/m)/(meter count)^{0.5}) of from 60 to 140. Moreover, in order to relieve the twist torque of a spun yarn, procedures including the following may be conducted: a spun yarn is conventionally steam set; when fluffs of a spun yarn are noticeable, the fluffs are removed by burning them, mechanically rubbing the spun yarn surface, or scraping surface fluffs off by traveling the yarn on a blade.

It is important in the present invention that the fiber forming the sewing thread contain 30% by weight or more of a poly(trimethylene terephthalate)-based staple fiber. That is, the sewing thread of the invention is a spun yarn composed of 100% of a poly(trimethylene terephthalate)-based staple fiber. Alternatively, it is composed of a twist yarn of a composite spun yarn, and it is formed by blending a poly(trimethylene terephthalate)-based staple fiber and at least one of the other staple fibers, and contains 30% by weight or more, preferably 50% by weight or more, particularly preferably 70% by weight or more of a poly(trimethylene terephthalate)-based staple fiber. When the content of a poly(trimethylene terephthalate)-based staple fiber is 30% by weight or more, the breaking elongation of the sewing thread can be made 30% or more, and the stretchability of seams obtained therefrom becomes excellent. When the content is less than 30% by weight, the sewing thread shows excellent sewing performance in lock stitching. However, the stretchability of seams becomes poor.

There is no specific restriction on fibers forming the sewing thread of the invention other than a poly(trimethylene terephthalate)-based staple fiber. Examples of the other fibers include natural fibers such as cotton, hemp, wool and silk, chemical fibers such as cuprammonium fibers, viscose fibers, polynosic fibers, purified cellulose fibers and acetate fibers, polyester-based fibers such as poly(ethylene terephthalate) fibers, poly(trimethylene terephthalate) fibers and poly(butylene terephthalate) fibers, various artificial fibers such as acrylic fibers and nylon fibers, copolymerized fibers obtained from substances forming the above fibers, and conjugate fibers (side-by-side type, eccentric sheath-core type, and the like) in which polymers of the same type or different types are used. A composite spun yarn of a poly(trimethylene terephthalate) with a poly(ethylene terephthalate) and/or a nylon is preferred because the tenacity of the sewing thread of the invention can be increased.

The method of blending fibers for obtaining a composite spun yarn is not particularly limited. Examples of the method include a method wherein raw staple fibers are blended with a poly(trimethylene terephthalate)-based staple fiber in a blowing and scutching process or a carding process, a method wherein slivers are piled one upon another into a composite form in a drawing process or a mixing gill step, or a method wherein, in a spinning process, a plurality of slivers or roving yarns are supplied, and spinning twist (SCIRO-spinning) is carried out thereon.

The spun yarn composed of a staple fiber and forming the sewing thread of the present invention preferably has the following physical properties: a breaking strength of 1.0 to 4.5 cN/dtex; a breaking elongation of 20 to 100%; and an elastic recovery at a 5% elongation of 70 to 100%.

The sewing thread of the present invention must show a breaking elongation of 30 to 100%, preferably 40 to 80%. When the breaking elongation is in the above range, the stretchability of a seam formed using the sewing thread becomes excellent. When the breaking elongation is less than 30%, the seam stretchability becomes insufficient. When the breaking elongation exceeds 100%, the elongation of a seam is obtained; however, the recovery becomes poor, and the shape stability of the seam becomes inadequate.

Furthermore, the sewing thread of the present invention must show an instantaneous elastic recovery at a 5% elongation of 30 to 75%. When the elastic recovery is in the above range, the sewing performance in lock stitching becomes excellent. When the sewing thread shows an instantaneous elastic recovery at a 5% elongation of less than 30%, the sewing performance in lock stitching is improved; however, the above breaking elongation range cannot be satisfied. Moreover, when the elastic recovery exceeds 75%, the shape of a needle thread loop becomes small in lock stitching. As a result, a seam is hard to form, and the sewing performance becomes poor. The sewing thread of the invention shows an elastic recovery at a 20% elongation is 60% or more, more preferably from 60 to 90%. When the elastic recovery is in the above range, the seam formed by sewing a stretchable fabric shows good adaptability to the movement of the fabric. Moreover, the sewing thread of the invention shows an elastic recovery at a 30% elongation of 60% or more, preferably 60 to 80%. When the elastic recovery is in the above range, the seam formed by sewing a particularly highly stretchable fabric shows good adaptability to the movement of the fabric.

The sewing thread of the present invention shows a breaking strength of 1.0 to 4.5 cN/dtex, particularly preferably 2.5 to 4.0 cN/dtex. When the breaking strength is less than 1.0 cN/dtex, an adequate seam tenacity is hardly given to sewn fabric articles. On the other hand, when the breaking strength exceeds 4.5 cN/dtex, the sewing thread shows a low breaking elongation, and the seam stretchability of the sewn fabric articles is significantly lowered. As a result, the articles give a poor wearable feel to the wearers sometimes.

For the sewing thread of the present invention, there is no specific restriction on the size of a spun yarn, a number of doubling and twisting a spun yarn, and a number of twists and a twisting direction of a plied yarn (when the yarn is plied). The yarn count is made to correspond to the application and required specification, and it can be suitably selected in accordance with the standard (JIS L 2511) related to a polyester sewing thread. For example, the yarn count can be suitably selected in accordance with a sewing thread yarn count such as #5, #8, #10, #20, #30, #40, #50, #60, #80 and #100.

When the sewing thread is to be formed, a spun yarn formed out of a poly(trimethylene terephthalate)-based staple fiber may further be twisted. Examples of the number of doubled yarns of the spun yarn can be selected from a two ply yarn (double ply yarn) obtained by doubling and twisting two yarns, a three ply yarn obtained by doubling and twisting three yarns, a 2×3 ply yarn obtained by doubling and twisting three yarns each of which has been obtained by doubling and twisting two yarns in advance, and the like. It is usually desirable that the number of second twists be from ([number of twisted yarns]^{0.5}×0.85) to ([number of twisted yarns]^{0.5}×1.15) against that of first twists (actual number of twists of the spun yarn) 1 to suppress the formation of a kinky yarn as much as possible. However, for a yarn such as a 2×3 ply yarn, because formation of a kinky yarn can be suppressed by carrying out twisting with a number of second twists against a number of intermediate twists 1 as mentioned above, the relationship of a number of intermediate twists against a number of first twists (actual number of twists of the spun yarn) 1 is not necessarily required to be as mentioned above. Moreover, the direction of second twist should fundamentally be the Z direction. However, for a sewing thread such as one for a two-needle lock stitch, both S twisting and Z twisting are preferably applied sometimes. Accordingly, there is no specific limitation on the direction of the second twist.

Next, the method of producing a sewing thread of the present invention will be explained.

The sewing thread of the invention can be produced by the following procedure: spun yarns (the twisting direction including the same direction or reverse direction) having the above physical properties and a desired size are doubled and twisted, or the doubled and twisted yarns are doubled and twisted to give a composite doubled and twisted yarn (hereinafter merely referred to as a doubled and twisted yarn); a yarn package is prepared from the doubled and twisted yarn, and the yarn package is wet heat treated at 90° C. or more while being in the same state.

Herein, the number of the doubled spun yarns, the number of doubling and twisting and the twisting direction applied in doubling and twisting, the number of twists, and the like are suitably selected in accordance with the design and specification of a known sewing thread, and a doubled and twisted yarn composed of a given number of ply is prepared using a known doubling and twisting machine such as an Italian throwing machine.

The yarn package of the doubled and twisted yarn is a cone or cheese of the doubled and twisted yarn formed on a bobbin such as a paper bobbin by winding means such as a soft winding machine in the final step of the doubling and twisting and having a given density of yarn winding.

The wet heat treatment is carried out by penetratively circulating superheated steam or water at 90° C. or more around the yarn package layer for 10 minutes or more. It is convenient and most preferred to carry out not only the wet heat treatment but also scouring or dyeing of the sewing thread using a package scouring machine or a dyeing machine. Circulation of a wet heat treatment medium around the doubled and twisted yarn layer having a given density of a yarn package in an out-in or in-out manner for a given time by the use of a package scouring machine or a dyeing machine can uniformly relax without disturbing the yarn layers, and adjust the structure and physical properties of the surface and inner layer portions of the sewing thread to predetermined conditions. It is preferred that the yarn package of the doubled and twisted yarn to be wet heat treated be formed to have a density of winding of from 0.25 to 0.7 g/cm³. When the density of winding is less than 0.25 g/cm³, the following disadvantages result: the shape of the yarn package becomes unstable and tends to collapse within a package scouring machine or a dyeing machine; the sewing thread becomes nonuniform; and there is a possibility that the doubled and twisted yarn is unevenly dyed or has nonuniform physical properties when the doubled and twisted yarn is dyed because a uniform flow of the dyeing solution is not effected.

On the other hand, when the density of winding exceeds 0.7 g/cm³, the density of winding of the yarn package increases due to the thermal shrinkage of the sewing thread during scouring and dyeing, and the inner and outer layers of the yarn package tend to have uneven dyeing and nonuniform physical properties because the flowability of the dyeing solution is suppressed. Moreover, in order to optionally obtain sufficient even dyeing and uniform physical properties by package scouring and dyeing, the following methods are appropriate ones, in addition to employing a yarn package having a density of winding of from 0.25 to 0.7 g/cm³: a method comprising soft winding the sewing thread on a bobbin (to be buckled) to form a cheese with a suitable density of winding as mentioned above, the method preventing an increase in the density of winding of the yarn package during package dyeing caused by a thread shrinkage, by means of bobbin buckling; and a method comprising replacing the bobbin on which a yarn package having a predetermined density of winding is formed with a perforated tube bobbin with perforations having a replaced bobbin ratio of from 5 to 30%, preferably from 5 to 15%, and wet heat treating the yarn package. The replaced bobbin ratio (%) herein is a value obtained by the following formula:
(1−[B/A])×100
wherein A is an outer diameter of a winding bobbin such as the winding paper bobbin of a winding machine, and B is an outer diameter of a perforated tube bobbin.

In order to improve the cohesiveness and sewing performance of a sewing thread, a solution containing a sewing performance improver, a smoothing agent and a binder may be circulated around the yarn package having been scoured or dehydrated after dyeing so that the agents are allowed to adhere to the yarn package. Alternatively, these agents may also be allowed to adhere to the yarn package having been wet treated, dyed and dried, by a continuous yarn treating machine (an apparatus for allowing a solution containing processing agents to adhere to the yarn while the yarn is being continuously unwound from the yarn package, drying and winding the yarn: for example, Unisizer (trade name, manufactured by Kaji Seisakusho K.K.)). Examples of the sewing performance improver and the smoothing agent include silicone compounds, polyethylene-based emulsions and wax compounds. Examples of the binder include polyester-based resins, polyurethane-based resins and acrylate-based resins.

A method of conducting wet heat treatment of a doubled and twisted yarn by means of scouring is a method comprising treating the yarn with a scouring solution containing such scouring agents for removing a finish oil on the yarn as nonionic surfactants and sodium carbonate at temperature from 50 to 100° C. for 10 to 30 minutes. A method of conducting wet heat treatment of a doubled and twisted yarn by means of dyeing is a method comprising circulating, after scouring the doubled and twisted yarn, a dyeing solution containing dispersion dyes, dispersants and acetic acid in an out-in manner, an in-out manner or an in-out-out-in manner around the yarn package at temperature from 90 to 130° C. for 15 to 120 minutes, more preferably at 110 to 130° C. A dyed sewing thread having predetermined uniform physical properties can be obtained by the method in a shorter period of time. A sewing thread obtained by package dyeing under the following conditions is particularly preferred because uniformity of dyeing and uniformity of the physical properties of the thread brought about by wet heat treatment are simultaneously achieved: a density of winding of the yarn package of from 0.25 to 0.7 g/cm³; and a replaced bobbin ratio (replacement with a dyeing tube (perforated tube bobbin)) of from 5 to 30%.

A stretchable fabric in the present invention signifies a fabric that shows an elongation in the warp and/or weft direction of from 5 to 200%. The elongation herein is obtained by the following procedure: two samples having dimensions of 140 mm×165 mm (tensile side×constrained side) with the tensile side of one sample taken in the warp direction of the fabric and that of the other sample taken in the weft direction are prepared; each sample is pulled at a rate of 60 cm/min so that an elongation-stress curve is depicted; an elongation of the fabric sample to which a stress of 2 kg/5 cm width is applied is calculated from the curve. In addition, a biaxial stretching machine (trade name of KES-G2, manufactured by Kato Tech K.K.) is used for the measurement. Examples of the fabric include a woven fabric, a knitted fabric and a nonwoven fabric. Of the fabrics, a woven fabric and a knitted fabric are especially preferred. Means for applying stretchability to these fabrics include a procedure that utilizes the stretchability of yarns forming the fabric, a procedure that utilizes the stretchability of the texture of the fabric, and a procedure that utilizes a combination of the above two procedures. Specific examples of the means include a procedure that utilizes a bare polyurethane-based yarn and a composite yarn such as a covered yarn, a procedure that utilizes the stretchability of a yarn obtained by crimping the yarn by means of false twisting, and a procedure that is a combination of these procedures. Specific and typical examples of applying stretchability to a texture include tubular knitting, warp knitting and weft knitting.

Specific examples of the stretchable fabric of the present invention include clothes showing an elongation of from 10 to 25% such as shirts, blouses, working clothes, uniforms, slacks, jackets, suits and coats, clothes showing an elongation of from 20 to 40% such as sports jackets, training wear, play wear, T-shirts, underwear and sweaters, and clothes showing an elongation of from 40 to 200% such as foundation garments, leotards, swimwear, skiwear and skate wear. Although the sewing thread of the invention can be used for sewing all these stretchable fabrics, it is preferably used for fabrics showing an elongation of 20% or more, particularly for fabrics showing an elongation of 60% or more because the seams are excellent in stretchability and the sewn articles thus obtained do not constrain the wearers and give them excellent wearability.

The sewing thread of the present invention is not limited to use for a machine sewing thread (industrial use, material use, home use), but it may be used as a hand sewing thread, a wadding, a linking thread, an embroidery yarn, and the like.

### BEST MODE FOR CARRYING OUT THE INVENTION

The present invention is more specifically explained below by making reference to examples. In addition, evaluations in examples are made by the following methods.

(1) Breaking Strength, Breaking Elongation

An initial load specified by a testing method of a general-purpose spun yarn according to JIS L 1095 is applied to a test sample held with a chuck-to-chuck distance of 30 cm in a constant elongation type tensile testing machine, and a tensile test is conducted at a pulling rate of 100% of the chuck-to-chuck distance per minute. The breaking strength (cN/dtex) and the breaking elongation (%) that is equal to a ratio of an elongation at break to the chuck-to-chuck distance are determined.

(2) Evaluation of Instantaneous Elastic Recovery

An initial load of 0.882 cN/dtex is applied to a sample held with a chuck-to-chuck distance of 20 cm, and the sample is elongated at a pulling rate of 5% of the chuck-to-chuck distance per minute. When the elongation reached 5%, the sample is conversely shrunk at the same rate. A stress-strain curve is depicted during the test. The residual elongation at a stress equal to the above initial load during the shrinkage is termed L (%), and the instantaneous elastic recovery at a 5% elongation is calculated from the following formula:
instantaneous elastic recovery at a 5% elongation=[(5−L)/5]×100%

(3) Evaluation of Elastic Recovery

An initial load specified by a testing method of a general-purpose spun yarn according to JIS L 1095 is applied to a test sample (spun yarn), and a test is conducted in accordance with an elastic recovery test method (A method). A chuck-to-chuck distance of a constant stretching type tensile testing machine is set at 20 cm, and a pulling rate is set at 100% of a chuck-to-chuck distance per minute. The sample is elongated to a given elongation L (20%=4 cm, 30%=6 cm), allowed to stand for 1 minute, allowed to recover at the same rate to the initial length, allowed to stand for 3 minutes, and elongated again at the same rate to a point L1 where the initial load is applied to the sample. The elastic recovery is obtained from the following formula:
elastic recovery (%)=[(L−L1)/L]×100

In addition, the test is repeated five times, and the average is obtained.

(4) Measurement of Intrinsic Viscosity [η]

The intrinsic viscosity [η] (dl/g) is a value determined on the basis of a definition of the following formula:
[η]=lim (ηᵣ−1)/C
C→0
wherein ηᵣ is a value obtained by dividing the viscosity at 35° C. of a diluted solution of a polymer that is prepared by dissolving the polymer in an o-chlorophenol solvent with a purity of 98% or more by the viscosity of the above solvent that is measured at the same temperature, and defined as a relative viscosity, and C is a polymer concentration in terms of g/100 ml.

(5) Evaluation of Sewn Articles

(i) Evaluation of Stretchability of Seams

Using a tubular knitting machine of 28 GG, a ponti roma texture was knitted by the following yarn arrangement.

Interlock portion:

a mixed filament yarn of poly(ethylene terephthalate) (cation dyeable yarn) of 56 dtex/cuprammonium rayon of 33 dtex

Gray sheeting portion of cylinder:

a mixed filament yarn of poly(ethylene terephthalate) (cation dyeable yarn) of 56 dtex/cuprammonium rayon of 33 dtex

Gray sheeting portion of dial:

A polyurethane-based elastic yarn (trade name of Roica, manufactured by Asahi Chemical Co., Ltd.) of 22 dtex and the same mixed filament yarn as in the interlock portion were doubled and fed while the polyurethane-based elastic yarn was being elongated by a ratio of 2.5. The knitted fabrics thus formed were each scoured, preset (at 180° C.), dyed at 100° C. for 30 minutes in two baths, and finished at 170° C. The stretch ratio of the stretchable knitted fabric (hereinafter referred to as a knitted fabric) thus obtained was measured with a biaxial stretching machine (manufactured by Kato Tech K.K.). The fabric showed a stretch ratio of 140.0% in the warp direction, and 88.5% in the weft direction under the testing condition of 2 kg/5 cm.

A sample having dimensions of 10 cm (warp)×20 cm (weft) is taken from the knitted fabric. The central portion of the sample is sewn in the warp direction using a lock stitch machine (trade name of DDL-555, manufactured by JUKI Corporation) under the following conditions: a J point needle (No. 11) as a sewing needle; a stitch number of 5 stitches/cm; and a speed of rotation of 1,000 rpm. Using a tensilometer (trade name of Tensilon, manufactured by Toyo Baldwin K.K.), the sample is elongated in the direction parallel to the seam, in accordance with the grab method by JIS L-1093, and a stress A (cN/cm) at an elongation of 60% and one at an elongation of 100% are measured. Next, a knitted fabric prior to sewing is elongated in the same manner, and a stress B (cN/cm) at an elongation of 60% and one at an elongation of 100% are measured.

The stretchability of the seam is evaluated from a difference between both values (stress A-stress B) at an elongation of 60% and a difference therebetween at an elongation of 100%. When the value is small, the stretchability is excellent.

(ii) Evaluation of Wearability

Using a knitted fabric obtained in (i), spats are prepared under the following conditions.

Size: No. 9

Grain: weft direction

Allowance: −5%

Sewing conditions: lock stitches, a sewing machine manufactured by Juki Corporation (trade name of DDL-555)
sewing needle: a J point needle (No. 11)
stitch number: 5 stitches/cm
speed of rotation: 1,000 rpm

Five panelists each having standard body dimensions are selected. They wear the above spats, go up and down stairs, bend and stretch, and each pedal a bicycle. The wearability during their action is evaluated in accordance with the following criteria: ⊚ (extremely comfortable), O (comfortable), Δ (slightly comfortable) and X (uncomfortable).

(6) Evaluation of Lock Stitch Sewing Performance

A sample having dimensions of 10 cm (warp)×100 cm (weft) is taken from the knitted fabric obtained in (i) of (5). The central portion of each of the three samples is continuously sewn in the warp direction using a lock stitch machine (trade name of DDL-555, manufactured by JUKI Corporation) under the following conditions: a J point needle (No. 11) as a sewing needle; a stitch number of 5 stitches/cm; and a speed of rotation of 4,000 rpm. The sewing performance is evaluated by evaluating yarn breakage and a seam appearance during sewing with a machine. The criteria of evaluation are mentioned below.

Yarn Breakage

O: No yarn breakage takes place during sewing the three samples.

Δ: Yarn breakage takes place once or less during sewing the three samples.

X: Yarn breakage takes place twice or more during sewing the three samples.

Appearance of Seams

O: Seams are uniform, and neither stitch skipping nor puckering takes place.

Δ: Seams are nonuniform.

X: Stitch skipping or puckering takes place.

### EXAMPLE 1

A poly(trimethylene terephthalate) ([η]=0.92) was spun at a spinning temperature of 265° C. and a spinning rate of 1,200 m/min to give an undrawn yarn. The undrawn yarn was then drawn at a hot roll temperature of 60° C., a hot plate temperature of 140° C., a draw ratio of 3 and a drawing rate of 800 m/min to give a drawn yarn of 84 dtex/50 f. The drawn yarn showed a breaking strength of 3.5 cN/dtex, a breaking elongation of 45% and an elastic recovery of 25.3 cN/dtex. Two hundred of the drawn yarns thus obtained were bundled, and a finish agent for filament yarn was removed in a scouring process. A finish oil for spinning containing potassium lauryl phosphate was applied to the drawn yarns in an amount of 0.1% o.w.f. The drawn yarns were then heat treated at 110° C. in a steam treating process, crimped with a stuffer box at 95° C., and cut at a fiber length of 38 mm with an EC cutter to give a poly(trimethylene terephthalate)-based staple fiber having a number of crimps of 16.4/25 mm and a degree of crimp of 15.8%.

The poly(trimethylene terephthalate)-based staple fiber thus obtained was subjected to a spinning process of conventional cotton spinning, and a spun yarn was produced with a ring spinning machine. The spun yarn was subjected to twist stop set at 80° C. for 15 minutes using a vacuum setter. The spun yarn thus obtained had a yarn count of 20/1 (296 dtex) in terms of cotton count and a twist factor K of 3.3 (number of twists S: 14.76 t/2.54 cm). Table 1 shows the physical properties.

Two of the spun yarns thus obtained were second twisted at a rate of 820 t/m (Z direction) with an Italian throwing machine. The plied yarn thus obtained was wound on a paper bobbin having a diameter of 78 mm at a density of winding of 0.40 g/cm³ (1 kg of coil) using a soft winder (manufactured by Kamitsu K.K.). The paper bobbin of the cheese was replaced with a dyeing tube (perforated tube bobbin) having an outer diameter of 69 mm, and the dyeing tube was placed in a package dyeing machine (manufactured by Hisaka Seisakusho K.K.). Scourol FC-250 (trade name, manufactured by Kao Corporation) was added to the scouring solution in an amount of 1 g/l, and the solution was heated to 60° C. from room temperature at a rate of 2° C./min while the solution was being allowed to flow at a rate of 40 l/min, followed by scouring the cheese at 60° C. for 10 minutes. The solution was then removed, and the cheese was washed with water. Dispersion dyes (trade name of Dianix Yellow AC-E (0.06% o.m.f.), Dianix Blue AC-E (0.08% o.m.f.) and Dianix Red AC-E (0.06% o.m.f.), manufactured by Dye Star K.K.) and a dispersant (trade name of Disper TL (0.5 g/l), manufactured by Meisei Kagaku K.K.) were added to the dyeing solution, and the pH was adjusted to 5 with acetic acid. The dyeing solution was heated to 120° C. at a rate of 2° C./min while being circulated in an in-out manner at a flow rate of 40 l/min, and the cheese was dyed at 120° C. for 30 minutes. The solution was removed, and the cheese was washed with water. A silicone finish oil (trade name of Dicsilicone Softener 500, manufactured by Dainippon Ink and Chemicals Incorporated) (5% o.m.f.) was added and the cheese was subjected to oiling treatment at 50° C. for 20 minutes. The cheese was dehydrated, and dried to give a sewing thread corresponding to #50. The sewing thread thus obtained was excellent in uniform dye-affinity. Table 2 shows the physical properties of the sewing thread. Table 3 shows the results of evaluating the wearability of sewn articles prepared using the sewing thread and the lock stitch sewing performance thereof.

The sewing thread was excellent in a lock stitch sewing performance. Seams prepared using the sewing thread had an excellent appearance and showed excellent stretchability. Sewn articles prepared using the sewing thread did not constrain the wearers, and gave them a comfortable feel.

### COMPARATIVE EXAMPLE 1

A spun yarn was produced in the same manner as in Example 1 except that a poly(ethylene terephthalate) staple fiber having a size of 1.7 dtex and a fiber length of 38 mm was used in place of the poly(trimethylene terephthalate)-based staple fiber in Example 1, and that the dyeing temperature in package dyeing was changed to 130° C. The spun yarns thus obtained were doubled and twisted and package dyed to give a sewing thread. In addition, Table 1 shows the physical properties of the spun yarn. Table 2 shows the physical properties of the sewing thread. Table 3 shows the results of evaluating the wearability of sewn articles prepared using the sewing thread and the lock stitch sewing performance of the sewing thread.

Because the sewing thread was composed of 100% of a poly(ethylene terephthalate)-based staple fiber, the seam stretchability was poor, and the sewn articles obtained using the sewing thread strongly constrained the wearers, and gave them an uncomfortable feel.

### EXAMPLE 2

A spun yarn was produced, and doubling and twisting and package dyeing were conducted to give a sewing thread in the same manner as in Example 1 except that 30% by weight of the poly(trimethylene terephthalate)-based staple fiber used in Example 1 and 70% by weight of a poly(ethylene terephthalate) staple fiber used in Comparative Example 1 were blended in the drawing process, and that the dyeing temperature in package dyeing was changed to 130° C. In addition, Table 1 shows the physical properties of the spun yarn. Table 2 shows the physical properties of the sewing thread. Table 3 shows the results of evaluating the wearability of sewn articles prepared using the sewing thread and the lock stitch sewing performance of the sewing thread.

The sewing thread was excellent in a lock stitch sewing performance. Seams prepared using the sewing thread showed an excellent appearance and excellent stretchability. Sewn articles prepared using the sewing thread did not constrain the wearers, and gave them a comfortable feel.

### EXAMPLE 3

A sewing thread was obtained in the same manner as in Example 2 except that the blend ratios of the poly(trimethylene terephthalate)-based staple fiber and the poly(ethylene terephthalate) staple fiber were changed to 70% by weight and 30% by weight, respectively. In addition, Table 1 shows the physical properties of the spun yarn. Table 2 shows the physical properties of the sewing thread. Table 3 shows the results of evaluating the wearability of sewn articles prepared using the sewing thread and the lock stitch sewing performance of the sewing thread.

The sewing thread was excellent in a lock stitch sewing performance. Seams prepared using the sewing thread showed an excellent appearance and excellent stretchability. Sewn articles prepared using the sewing thread did not constrain the wearers, and gave them a comfortable feel.

### EXAMPLE 4

Two types of poly(trimethylene terephthalate) differing from each other in intrinsic viscosity were extruded in an eccentric sheath-core manner (high viscosity side being in the core portion) in a weight ratio of 1:1 at a spinning temperature of 265° C. and a spinning rate of 1,500 m/min to give an undrawn yarn. The undrawn yarn was then drawn and at a hot roll temperature of 55° C., a hot plate temperature of 140° C. and a drawing rate of 400 m/min while the draw ratio was determined so that the size after drawing became 84 dtex, to give an eccentric sheath-core type conjugate multifilaments having a size of 84 dtex/36 f. The conjugate multifilaments thus obtained had the following intrinsic viscosities: [η]=0.92 on the high viscosity side; and [η]=0.70 on the low viscosity side.

Using the conjugate multifilaments thus obtained, a poly(trimethylene terephthalate)-based staple fiber having a fiber length of 38 mm was obtained in the same manner as in Example 1 except that crimping with a stuffer box was not conducted. The poly(trimethylene terephthalate)-based staple fiber thus obtained had a number of crimps of 13.2/25 mm and a degree of crimp of 17.5%.

A spun yarn was prepared from the poly(trimethylene terephthalate)-based staple fiber thus obtained, and the spun yarn was doubled and twisted and package dyed in the same manner as in Example 1 to give sewing thread. In addition, Table 1 shows the physical properties of the spun yarn. Table 2 shows the physical properties of the sewing thread. Table 3 shows the results of evaluating the wearability of sewn articles prepared using the sewing thread and the lock stitch sewing performance of the sewing thread. The sewing thread was excellent in lock stitch sewing performance. Seams prepared using the sewing thread had an excellent appearance and showed excellent stretchability. Sewn articles prepared using the sewing thread did not constrain the wearers, and gave them a comfortable feel.

### COMPARATIVE EXAMPLE 2

A poly(trimethylene terephthalate) ([η]=0.8) was spun at a spinning temperature of 265° C. and a spinning rate of 1,200 m/min to give an undrawn yarn. The undrawn yarn was then drawn at a hot roll temperature of 60° C., a hot plate temperature of 140° C., a draw ratio of 3 and a drawing rate of 800 m/min to give a drawn yarn of 84 dtex/36 f. Table 1 shows the physical properties of the drawn yarn.

A drawn yarn of the poly(trimethylene terephthalate) multifilaments thus obtained was first twisted at a rate of 800 t/m (S direction) with an Italian throwing machine. Three of such yarns were doubled, and final twisted at a rate of 600 t/m (Z direction) to give a three ply yarn.

The three ply yarn thus obtained was treated in the same manner as in Example 1 to give a sewing thread.

In addition, Table 1 shows the physical properties of the spun yarn. Table 2 shows the physical properties of the sewing thread. Table 3 shows the results of evaluating the wearability of sewn articles prepared using the sewing thread and the lock stitch sewing performance of the sewing thread.

The sewing thread showed an instantaneous elastic recovery at a 5% elongation as high as 90%, and seams prepared using the sewing thread showed excellent stretchability. Sewn articles prepared using the sewing thread did not constrain the wearers, and gave them a comfortable feel. However, the sewing thread showed a poor lock stitch sewing performance.

TABLE 1

| | EX. 1 | Ex. 2 | | Ex. 3 | | Ex. 4 | Comp. Ex. 1 | Comp. Ex. 2 |
|---|---|---|---|---|---|---|---|---|
| Fiber shape | Staple | Staple | | Staple | | Staple | Staple | Filament |
| | fiber | fiber | | fiber | | fiber | fiber | yarn |
| Fiber | PTT | PTT | PET | PTT | PET | PTT/PTT | PET | PTT |
| Blending ratio | 100 | 30 | 70 | 70 | 30 | 100 | 100 | 100 |
| (wt. %) | | | | | | | | |
| Single filament | 1.7 | 1.7 | 1.7 | 1.7 | 1.7 | 2.3 | 1.7 | 2.3 |
| thickness (dtex) | | | | | | | | |
| Fiber length (mm) | 38 | 38 | 38 | 38 | 38 | 38 | 38 | — |
| Number of crimps | 16.4 | 16.4 | 13.7 | 16.4 | 13.7 | 13.2 | 13.7 | — |
| ( 1/25 mm) | | | | | | | | |
| Degree of crimp | 15.8 | 15.8 | 15.1 | 15.8 | 15.1 | 17.5 | 15.1 | — |

| | | | | | | |
|---|---|---|---|---|---|---|
| Yarn count (cotton | 20/1 | 20/1 | 20/1 | 20/1 | 20/1 | 84dtex/36f |
| count) or filament | | | | | | |
| structure (dtex/f) | | | | | | |
| Twist factor K | 3.3 | 3.3 | 3.3 | 3.3 | 3.3 | — |
| Breaking strength | 2.2 | 2.9 | 2.6 | 1.7 | 3.9 | 3.5 |
| (cN/dtex) | | | | | | |
| Breaking elongation | 37 | 32 | 35 | 40 | 15 | 40 |
| (%) | | | | | | |
| Instantaneous | 81 | 73 | 77 | 85 | 58 | 95 |
| elastic recovery at | | | | | | |
| 5% elongation (%) | | | | | | |

TABLE 2

| | EX. | Ex. | Ex. | Ex. | Comp. | Comp. |
|---|---|---|---|---|---|---|
| | 1 | 2 | 3 | 4 | Ex. 1 | Ex. 2 |
| Breaking strength | 2.0 | 2.7 | 2.5 | 1.6 | 3.7 | 3.2 |
| (cN/dtex) | | | | | | |
| Breaking elongation | 72 | 60 | 65 | 78 | 27 | 58 |
| (%) | | | | | | |
| Instantaneous elastic | 65 | 55 | 61 | 67 | 49 | 89 |
| recovery at 5% | | | | | | |
| elongation (%) | | | | | | |
| Elastic recovery at | 79 | 65 | 73 | 82 | 48 | 83 |
| 20% elongation (%) | | | | | | |
| Elastic recovery at | 71 | 61 | 68 | 75 | Broken | 75 |
| 30% elongation (%) | | | | | | |

TABLE 3

| | EX. | Ex. | Ex. | Ex. | Comp. | Comp. |
|---|---|---|---|---|---|---|
| | 1 | 2 | 3 | 4 | Ex. 1 | Ex. 2 |
| Seam stretchability | 150 | 250 | 190 | 140 | 400 | 170 |
| at 60% elongation | | | | | | |
| (cN/dtex) | | | | | | |
| Seam stretchability at | 210 | 310 | 250 | 200 | Broken | 220 |
| 100% elongation | | | | | | |
| (cN/dtex) | | | | | | |
| Wearability | [symbol] | ◯ | [symbol] | [symbol] | X | [symbol] |
| Lock stitch sewing | ◯ | ◯ | ◯ | ◯ | ◯ | X |
| performance-yarn | | | | | | |
| breakage | | | | | | |
| Lock stitch sewing | ◯ | ◯ | ◯ | ◯ | ◯ | Δ |
| performance-seam | | | | | | |
| appearance | | | | | | |

### INDUSTRIAL APPLICABILITY

The sewing thread of the present invention is a stretchable one excellent in a lock stitch sewing performance, and seams prepared using the sewing thread have an excellent seam appearance and show excellent stretchability. The sewing thread displays excellent adaptability to sewing a stretchable fabric. Because seams excellent in adaptability to dynamic body movement are formed in the stitched portions of sewn articles obtained by the use of the sewing tread of the present invention, the present invention can provide sewn clothes that less constrain the wearers and give them a comfortable feel. Use of the sewing thread of the present invention can provide stretchable sewn fabric articles having seams that are dynamically adapted to a stretching and shrinking movement of the sewn fabrics and excellent in appearance.

1. A sewing thread containing 30% by weight or more of a poly(trimethylene terephthalate)-based staple fiber, and showing a breaking elongation of 30 to 100% and an instantaneous elastic recovery at a 5% elongation of 30 to 75%.

2. The sewing thread according to claim 1, wherein the elastic recovery at a 20% elongation is 60% or more.

3. A sewing thread according to claim 1, wherein the elastic recovery at a 30% elongation is 60% or more.

4. Sewn fabric articles wherein the seams of the sewn fabric articles are formed with the sewing thread according to any one of claims 1 to 3.

5. The sewn fabric articles according to claim 4, wherein the sewn fabric articles are stretchable ones.
